(19) United States
(12) Patent Application Publication
(10) Pub. No.: US 2026/0307155 A1
(43) Pub. Date: Oct. 8, 2026

(54) BIT HOLDER

(71) Applicant: MILWAUKEE ELECTRIC TOOL CORPORATION, Brookfield, WI (US)

(72) Inventors: Matthew J. Fiddes, Milwaukee, WI (US); Katherine J. Haim, Waukesha, WI (US); Kyle A. Tacoronte, Port Washington, WI (US); Praneeth Gandi, Pewaukee, WI (US); Conor G. Stevens, Milwaukee, WI (US)

(21) Appl. No.: 19/641,296

(22) Filed: Apr. 7, 2026

Related U.S. Application Data
(60) Provisional application No. 63/784,473, filed on Apr. 7, 2025.

(51) Int. Cl. B23B 31/107; B25B 23/00

(52) U.S. Cl. CPC B23B 31/1071; B25B 23/0035; B23B 2260/008

(57) ABSTRACT

A bit holder may include a shank extending along an axis, the shank having a tool end configured to be coupled to the power tool and a bit end opposite the tool end, the shank defining a groove of a first depth and a cutout of a second depth that is greater than the first depth, the cutout being closer than the groove to the bit end. A bit holder may include a bit holding body defining a longitudinal bore that receives a portion of the shank and an aperture defined in a surface of the bit holding body that is in fluid communication with the longitudinal bore. A bit holder may include a bearing received at least partially in the aperture, wherein the bearing is movable to the cutout to permit a sleeve to be moved along the bit holding body and into position surrounding the groove.

### CROSS-REFERENCE TO RELATED APPLICATIONS

This application claims priority to U.S. Provisional Patent Application No. 63/784,473 filed on April 7, 2025, the entire content of which is incorporated herein by reference.

### FIELD OF THE INVENTION

The present invention relates to power tool accessories. More specifically, the present invention relates to bit holders.

### BACKGROUND

Bits are attached to power tools to transmit forces and torques from the power tool to perform a working operation. Bit holders connect bits to the power tool. Some bit holders operate differently in normal conditions in comparison to force or torque overload conditions. However, such bit holders are difficult to assemble. For example, known bit holders include sleeves that are clipped to bit holding bodies.

### SUMMARY

In one aspect, the disclosure provides a bit holder configured to be driven by a power tool, the bit holder including: a shank extending along an axis, the shank having a tool end configured to be coupled to the power tool and a bit end opposite the tool end, the shank defining a groove of a first depth and a cutout of a second depth that is greater than the first depth, the cutout being closer than the groove to the bit end; a bit holding body defining a longitudinal bore that receives a portion of the shank and an aperture defined in a surface of the bit holding body that is in fluid communication with the longitudinal bore; and a bearing received at least partially in the aperture; wherein the bearing is movable to the cutout to permit a sleeve to be moved along the bit holding body and into position surrounding the groove.

In another aspect, the disclosure provides a bit holder configured to be driven by a power tool, the bit holder including: a shank extending along an axis, the shank configured to be coupled to the power tool, the shank defining a groove; a bit holding body defining a longitudinal bore that receives a portion of the shank, the bit holding body having an outer surface; and a sleeve disposed over the shank and the bit holding body, the sleeve movable relative to the shank and the bit holding body to shift the bit holder between a first state, in which the shank is configured to transfer torque from the power tool to the bit holding body, and a second state, in which the shank is rotatable independently of the bit holding body; wherein the sleeve is secured to the bit holding body without a clip.

In another aspect, the disclosure provides a method of assembling a bit holder, the method including: advancing a shank into a bit holding body to align a shank cutout of the shank with a first bit holding body aperture of the bit holding body; inserting a first bearing into the shank cutout and the first bit holding body aperture; sliding a first sleeve over the bit holding body until a first sleeve groove of the first sleeve aligns with the first bearing; and subsequently advancing the shank into the bit holding body such that the first bearing disengages the shank cutout and engages a first shank groove of the shank.

In one aspect, the disclosure provides a bit holder configured to be driven by a power tool, the bit holder including: a shank extending along an axis, the shank having a tool end configured to be coupled to the power tool and a bit end opposite the tool end, the shank defining a groove of a first depth, and a cutout of a second depth greater than the first depth, the cutout being closer to the bit end than the groove; a bit holding body defining a longitudinal bore that receives a portion of the shank and an aperture defined in a surface of the bit holding body that is in fluid communication with the longitudinal bore; and a bearing received at least partially in the cutout; wherein the bearing is movable to the cutout to permit a sleeve to be moved along the bit holding body and into position surrounding the groove

In another aspect, the disclosure provides a bit holder configured to be driven by a power tool, the bit holder including: a shank extending along an axis, the shank configured to be coupled to the power tool, the shank defining a groove, a bit holding body defining a longitudinal bore that receives a portion of the shank, the bit holding body having an outer surface; a sleeve disposed over the shank and the bit holding body, the sleeve movable relative to the shank and the bit holding body to shift the bit holder between a normal state in which the shank is configured to transfer torque from the power tool to the bit holding body, and a torque overload state in which the shank rotated independently of the bit holding body, wherein the sleeve is disposed over the bit holding body and secured to the bit holding body without coupling a clip to the outer surface of the bit holding body.

In another aspect, the disclosure provides a method of assembling a bit holder, the method including: advancing a shank into a bit holding body to align a shank cutout of the shank with a first bit holding body aperture of the bit holding body, inserting a first bearing into the shank cutout and the first bit holding body aperture, sliding a first sleeve over the bit holding body until a first sleeve groove of the first sleeve aligns with the first bearing, and subsequently advancing the shank into the bit holding body such that the first bearing disengages the shank cutout and engages a first shank groove of the shank.

Other aspects of the invention will become apparent by consideration of the detailed description and accompanying drawings.

### BRIEF DESCRIPTION OF THE DRAWINGS

FIG. 1 is perspective view of a bit holder including a shank, a bit holding body, and a sleeve according to an embodiment of the disclosure.

FIG. 2 is a side view of the shank of FIG. 1.

FIG. 3 is an exploded view of the bit holder of FIG. 1.

FIG. 4A is a cross-sectional view of the bit holder of FIG. 1 taken along section line 4—4 in FIG. 1 in a normal state.

FIG. 4B is a cross-sectional view of the bit holder of FIG. 1 taken along section line 4—4 in FIG. 1 in a torque overload state.

FIG. 5 is a flowchart depicting a method of manufacturing a bit holder.

FIG. 6 is a cross-sectional view depicting a shank insertion step.

FIG. 7 is a cross-sectional view depicting a first bearing insertion step.

FIG. 8 is a cross-sectional view depicting a first sleeve introduction step.

FIG. 9 is a cross-sectional view depicting a sleeve insertion step.

FIG. 10 is a cross-sectional view depicting a first shank advancing step.

FIG. 11 is a cross-sectional view depicting a second shank advancing step.

FIG. 12 is a cross-sectional view depicting a second bearing insertion step.

FIG. 13 is a cross-sectional view depicting a shank retreating step.

FIG. 14 is a cross-sectional view depicting a second sleeve introduction step.

FIG. 15 is a cross-sectional view depicting a compression step.

FIG. 16 is a cross-sectional view depicting a third shank advancing step.

FIG. 17 is a cross-sectional view depicting a fully assembled bit holder.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

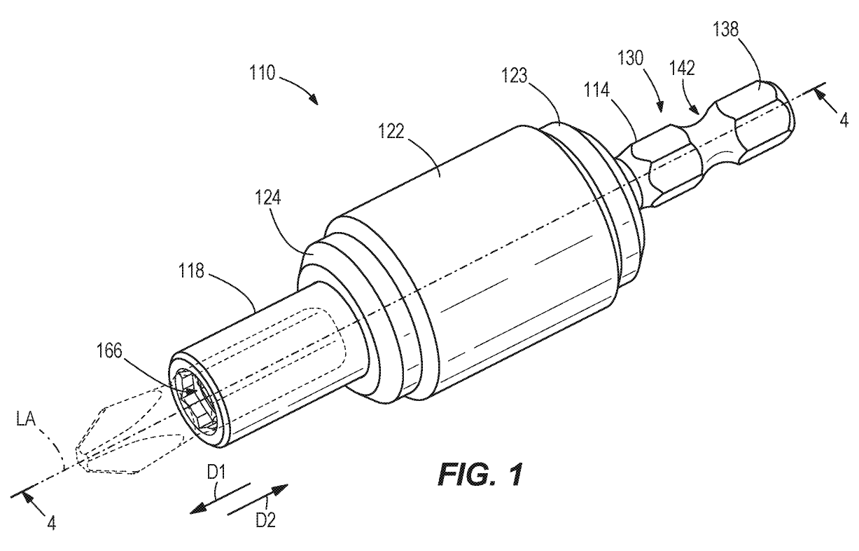

FIGS. 1-4B illustrate a bit holder 110 including a shank 114, a bit holding body 118, a shroud 122, a first sleeve 123, a second sleeve 124, and a spring 125 (FIG. 3). The bit holder 110 defines an axis LA that extends longitudinally through the center of the bit holder 110. The bit holder 110 is configured to rotate about the axis LA. The shank 114 is configured to be coupled to a power tool for rotation of the bit holder 110. The bit holding body 118 is configured to retain a tool bit B such that the power tool drives rotation of the bit holder 110 and the tool bit B. The tool bit B may be, for example, a drill bit, a driver bit, and the like. Each of the shroud 122, the first sleeve 123, the second sleeve 124, and the spring 125 is disposed around both the shank 114 and the bit holding body 118 to absorb shock from operation of the bit holder 110. The spring 125 is positioned in an axial direction parallel to the axis LA sandwiched between the first sleeve 123 and the second sleeve 124. The spring 125 may bias the second sleeve 124 in a forward direction D1 toward the front of the bit holder 110. The spring 125 is positioned in a radial direction perpendicular to the axis LA between the shroud 122 and the bit holding body 118. As such, as the power tool transfers torque to the shank 114, the shank 114 may then transfer torque to the tool bit B via either the shroud 122, the bit holding body 118, or both, as will be described in further detail below.

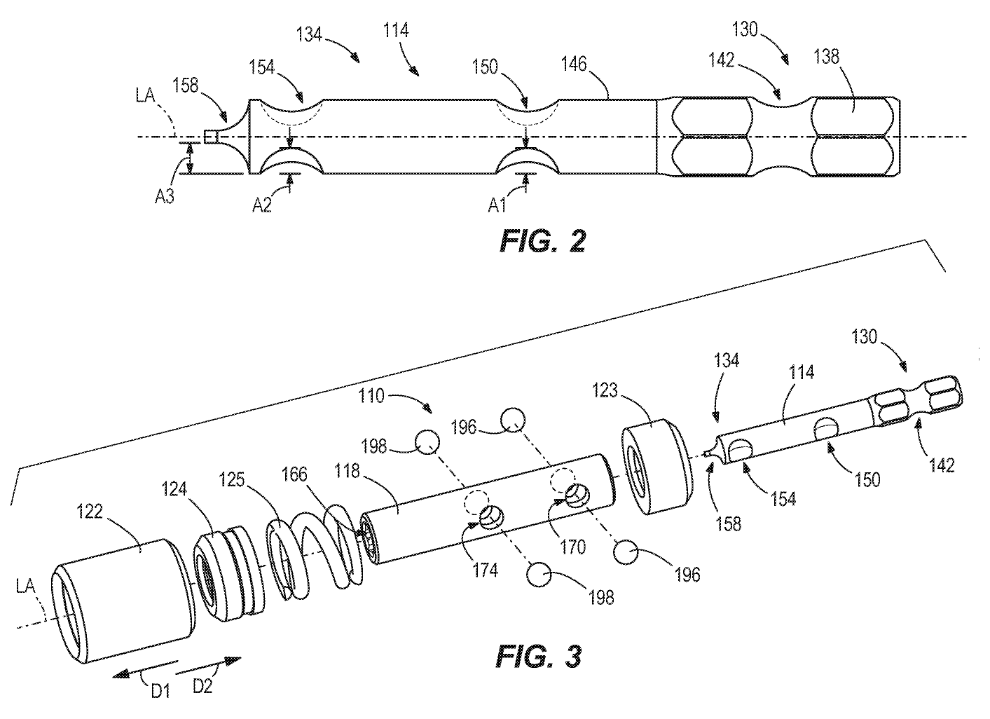

As illustrated in FIG. 2, the shank 114 includes a tool coupling portion 130 and a bit holding coupling portion 134. The tool coupling portion 130 includes a body 138 and a groove 142. In the illustrated embodiment, the body 138 has a hexagonal cross-section perpendicular to the axis LA. At least a portion of the body 138 is engageable with the power tool to rotationally couple the shank 114 to the power tool, and the groove 142 may receive a retention member from the power tool (e.g., a detent ball, a clip, etc.) to maintain engagement between the shank 114 and the power tool. In some embodiments, the body 138 of the tool coupling portion 130 may have a different shape. For example, in some embodiments, the tool coupling portion 130 may be configured as an SDS-style shank, such as an SDS shank, an SDS Plus shank, or an SDS Max shank.

With reference to FIG. 2, the bit holding coupling portion 134 is configured to be inserted into the bit holding body 118 to couple the shank 114 to the bit holding body 118. The bit holding coupling portion 134 includes a generally cylindrical outer surface 146 which has a first groove 150 and a second groove 154 formed therein. In the illustrated embodiment, the bit holding coupling portion 134 includes a plurality of first grooves 150 and a plurality of second grooves 154. More specifically, the plurality of first grooves 150 includes two first grooves 150 spaced diametrically apart from each other with respect to the axis LA, and the plurality of second grooves 154 includes two second grooves 154 spaced diametrically apart from each other with respect to the axis LA. Other embodiments may have different quantities and/or circumferential spacing of either or both of the first grooves 150 and the second grooves 154. In the illustrated embodiment, each of the first grooves 150 is circumferentially arranged with respect to the axis LA in correspondence to the same circumferential arrangement of the second grooves 154. As illustrated in FIG. 2, the first grooves 150 are above and below the axis LA, and the second grooves 154 are also above and below the axis LA. The first grooves 150 are positioned axially between the second grooves 154 and the tool coupling portion 130.

The plurality of first grooves 150 are semi-circular in shape and define a first depth A1 (FIG. 2). The first depth A1 extends in a radially inward direction from the outer surface 146 toward the axis LA to the deepest location of the first grooves 150 closest to the axis LA. Similarly, the plurality of second grooves 154 are semi-circular in shape and define a second depth A2. In the illustrated embodiment, the first depth A1 and the second depth A2 are the same. A tip of the bit holding coupling portion 134 furthest from the tool coupling portion 130 defines a cutout 158. The cutout 158 is semi-circular in shape and defines a third depth A3 that extends in a radially inward direction from the outer surface 146 toward the axis LA. The cutout 158 intersects with the tip of the bit holding coupling portion 134 with the semi-circular shape thereof being generally a quarter circle revolved about the axis LA. The third depth A3 is nominally larger than the first depth A1 and the second depth A2. In other words, the cutout 158 is deeper than the first grooves 150 and the second grooves 154. Operation of the cutout 158 is described in further detail below.

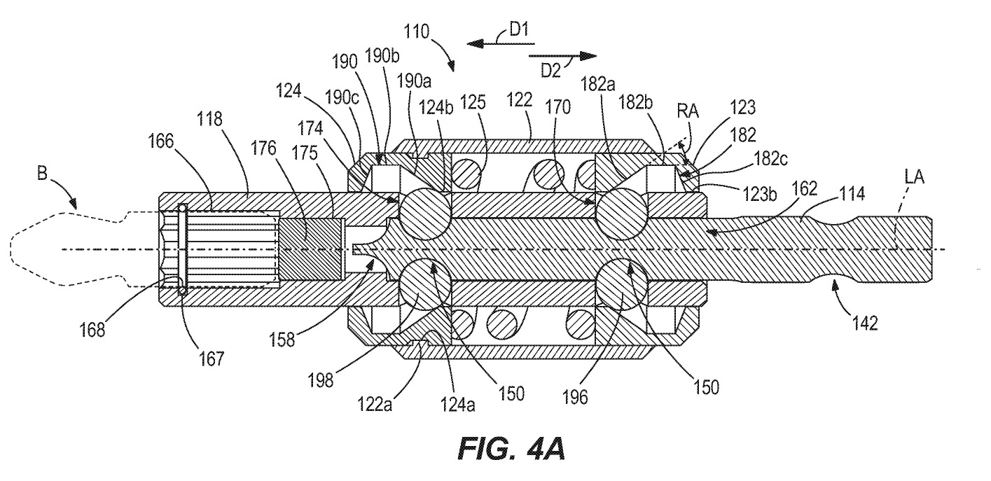

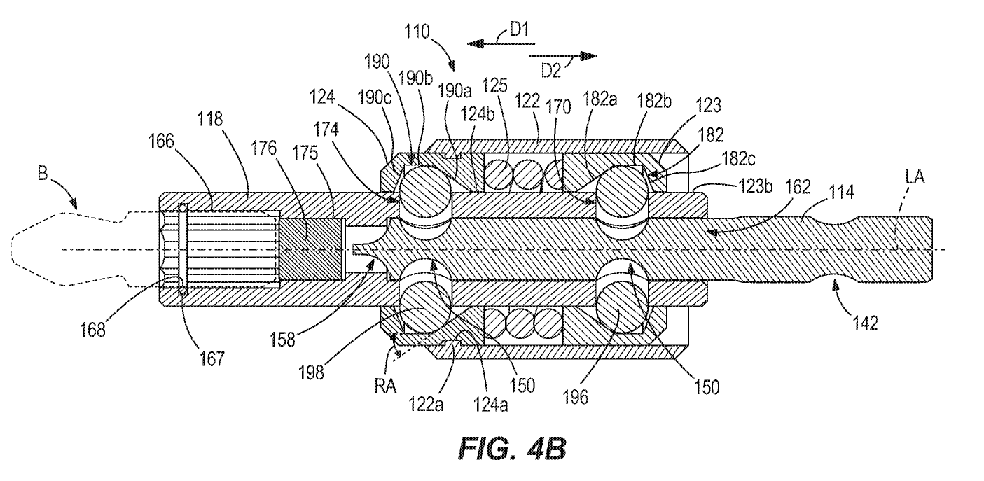

As illustrated in FIGS. 3-4B, the bit holding body 118 defines a longitudinal bore 162 with a tool bit receiving aperture 166, a plurality of first apertures 170, and a plurality of second apertures 174. The longitudinal bore 162 includes a magnet retention surface 175 which receives a magnet 176. The magnet 176 separates the tool bit receiving aperture 166 from the remainder of the longitudinal bore 162. The first apertures 170 and the second apertures 174 are configured to receive the bit holding coupling portion 134. In other embodiments, the bit holding body 118 may not include a magnet 176, and the tool bit receiving aperture 166 may be in fluid communication with the longitudinal bore 162. In other embodiments, the magnet retention surface 175 may be redesigned as a wall perpendicular to the axis LA to separate the tool bit receiving aperture 166 from the remainder of the longitudinal bore 162. The magnet 176 may assist in retaining an axial position of the tool bit B along axis LA within the tool bit receiving aperture 166. When the bit holder 110 is assembled (FIGS. 4A, 4B), an opening to the tool bit receiving aperture 166 is disposed at an end of the bit holder 110 that is opposite from the shank 114, and the tool bit receiving aperture 166 is configured to receive the tool bit B therein. The illustrated bit receiving aperture 166 has a hexagonal cross-section but may alternatively have other configurations to receive other types of tool bits. The bit receiving aperture 166 may optionally include a recess 167 within which a retainer 168 (e.g., an O-ring) is positioned to further assist in retaining an axial position of the tool bit B along axis LA within the tool bit receiving aperture 166. The recess 167 is annular in shape about the axis LA and is provided on an inner radial surface of the tool bit receiving aperture 166.

In the illustrated embodiment, two first apertures 170 are spaced diametrically across from one another with respect to the axis LA. Similarly, two second apertures 174 are spaced diametrically across from one another with respect to the axis LA and in correspondence with a circumferential position about the axis LA of the two first apertures 170. In some embodiments, the first aperture 170 and the second aperture 174 may each only include one opening. In other embodiments, each aperture 170, 174 may include more than two openings. Each of the first apertures 170 circumferentially aligns with one of the first grooves 150, and each of the second apertures 174 circumferentially aligns with one of the second grooves 154.

With reference to FIG. 4A, the shroud 122 is generally annular about the axis LA and includes a protrusion 122a that couples the shroud 122 to the second sleeve 124. As such, the shroud 122 is fixed to the second sleeve 124 and movable (e.g., slidable) relative to the first sleeve 123. In the illustrated embodiment, the shroud 122 is overmolded to the second sleeve 124 and the protrusion 122a is integrally formed with the remainder of the shroud 122. The protrusion 122aengages a correspondingly shaped recess 124a of the second sleeve 124. Alternatively, the first sleeve 123 may be provided with the recess 124ato engage the protrusion 122a. In the illustrated embodiment, the protrusion 122a and recess 124a each extend a full revolution circumferentially about the axis LA. However, in other embodiments, the protrusion 122a and recess 124a may extend circumferentially about only a portion of the axis LA. Alternatively, one or more protrusions 122aand recesses 124a may be present and circumferentially spaced about the axis LA. In other embodiments, the shroud 122 may be coupled to the second sleeve 124 by snap-fit or other coupling means, such as adhesives or fasteners. In other embodiments, the shroud 122 may be overmolded or otherwise coupled to the second sleeve 124. In embodiments where the protrusion 122ais overmolded to the shroud 122, no additional clip or mechanical retaining structure is needed to secure the shroud 122 to the second sleeve 124. Since no additional clip or mechanical retaining structure is needed, assembly process of the bit holder 110 is simplified as explained in detail below.

The shroud 122 may be formed of a transparent or opaque material. The shroud 122 may be formed of a generally rigid material such as plastic. Alternatively, the shroud 122 may be formed of metal or another rigid material. The shroud 122 may cover and surround the spring 125. The illustrated spring 125 is a coil compression spring. In the illustrated embodiment, the spring 125 is made of a metal material capable of elastic deformation. In other embodiments, the spring 125 may be made of other materials and/or have other configurations. An inner diameter of the shroud 122 is dimensioned to closely fit an outer diameter of the first sleeve 123 such that the shroud 122 is permitted to translate relative to the first sleeve 123 but the shroud 122 and the first sleeve 123 together inhibit ingress of debris, fluid, or other substances into the annular shroud 122 and to shield the spring 125 from the same.

As illustrated in the embodiment of FIGS. 9-17, a flexible sleeve 126 may replace the shroud 122 and spring 125. The flexible sleeve 126 may be formed of rubber or any similar flexible material such as, for example, neoprene, silicone, natural rubber, and the like. The flexible sleeve 126 may be elastically deformable and function as the spring 125 to bias the second sleeve 124 towards the front of the bit holder 110. As such, the flexible sleeve 126 may also be considered a spring. The flexible sleeve 126 is located radially outboard of the bit holding body 118 and axially between the first sleeve 123 and the second sleeve 124. The flexible sleeve 126 may bias the second sleeve 124 toward the front of the bit holder 110.

With reference to FIGS. 4A-4B, the first sleeve 123 has a stepped annular shape with an interior annular surface 123b closest to the axis LA. The interior annular surface 123bdefines a first sleeve groove 182 defined by a transition portion 182a, a cylindrical portion 182b, and an end portion 182c. Similarly, the second sleeve 124 has an interior annular surface 124b with a stepped annular shape with a second sleeve groove 190 defined by a transition portion 190a, a cylindrical portion 190b, and an end portion 190c. The transition portions 182a, 190aare each planar surfaces revolved a full revolution about the axis LA and that are angled with respect to the axis LA by a ramp angle RA. In the illustrated embodiment, the ramp angle is approximately 35 degrees as measured with respect to the cylindrical portions 182b, 190b. In other embodiments, other ramp angles RA may be used, such as ramp angles RA between 30 degrees and 40 degrees, or between 20 degrees and 50 degrees.

The first apertures 170 are configured to receive first bearings 196, and the second apertures 174 are configured to receive second bearings 198. More specifically, each of the first apertures 170 receives one first bearing 196 therein, and each of the second apertures 174 receives one second bearing 198 therein. In other embodiments, the bit holder 110 may include fewer or more bearings, depending on the number of apertures 170, 174. In the normal state (e.g., inboard position of bearings 196, 198 with respect to the axis LA), each of the first bearings 196 are disposed in one of the first apertures 170 and one of the first grooves 150, and each of the second bearings 198 are disposed in one of the second apertures 174 and one of the second grooves 154. In the normal state, the first bearings 196 and the second bearings 198 are positioned in the apertures 170, 174 such that the shank 114 is inhibited from rotating about the axis LA and relative to the bit holding body 118.

With continued reference to FIGS. 4A and 4B, during operation of the bit holder 110 with the bit holder 110 in the normal state (FIG. 4A), a user may insert the shank 114 into a power tool and may insert a tool bit B into the tool bit receiving aperture 166 of the bit holding body 118. The user may then actuate the power tool to drive rotation of the shank 114. As the shank 114 rotates, the shank 114 transfers torque to the first bearings 196 and the second bearings 198, which in turn, transfer torque to the bit holding body 118 to drive rotation of the tool bit B for performing a working operation. As the tool bit is driven, the bit holder 110 may reach a torque threshold (e.g., reach and/or exceed a predetermined torque threshold) such that the bit holder 110 is overloaded. After the bit holder reaches the torque threshold, the bit holder 110 shifts from the normal state to a torque overload state (FIG. 4B). During this shift, the transition portions 182a, 190a provide a variable inner dimension transition portion (e.g., a variable inner diameter) to permit movement of the bearings 196, 198 between an inboard normal position (FIG. 4A) and an outboard torque overload position (FIG. 4B).

In the torque overload state, the first bearings 196 move against the first sleeve 123 (e.g., to an outboard position with respect to the axis LA), thereby causing a reactionary movement of the first sleeve 123 in the forward direction D1 against the bias of the spring 125. Further in the torque overload state, the second bearings 198 move against the second sleeve 124, thereby causing a reactionary movement of the second sleeve 124 in the reverse direction D2 that is opposite the first direction D1. In the illustrated embodiment, the first direction D1 is oriented in the direction from the shank 114 to the bit holding body 118, and the second direction D2 is oriented in the direction from the bit holding body 118 to the shank 114. As such, the spring 125 (or the flexible sleeve 126) may be compressed between the first sleeve 123 and the second sleeve 124 in the torque overload state. When the first sleeve 123 moves in the first direction D1, the first bearings 196 may move into the first sleeve groove 182, and the second bearings 198 may move into the second sleeve groove 190 such that the spring 125, the first sleeve 123 and the second sleeve 124 at least partially absorb the torque overload. In some instances, the bit holding body 118 may move in the second direction D2 as the bit holder 110 shifts from the normal state to the torque overload state.

With the first bearings 196 positioned in the first sleeve groove 182 and the second bearings 198 positioned in the second sleeve groove 190, the first bearings 196 and the second bearings 198 no longer provide an interference between the shank 114 and the bit holding body 118. That is, the first bearings 196 and the second bearings 198 move a distance out of the plurality of first grooves 150 and the plurality of second grooves 154, respectively, such that the first bearings 196 and the second bearings 198 no longer inhibit rotation of the shank 114 relative to the bit holding body 118. As such, the power tool may drive rotation of the shank 114 independently of the bit holding body 118 when the first bearings 196 and the second bearings 198 move out of the first grooves 150 and the second grooves 154, respectively. That is, the power tool drives rotation of the shank 114, but the shank 114 does not transfer torque to the bit holding body 118 in the torque overload state. In other words, in the torque overload state, the shank 114 may freely spin within the bit holding body 118. Since no torque is transferred in the torque overload state, after the bit holder 110 shifts to the torque overload state, a user may release actuation of the power tool to stop rotation of the shank 114. In absence of torque provided by the power tool, the spring 125 may automatically bias the second sleeve 124 forwardly away from the first sleeve 123 to shift the bit holder 110 back into the normal state.

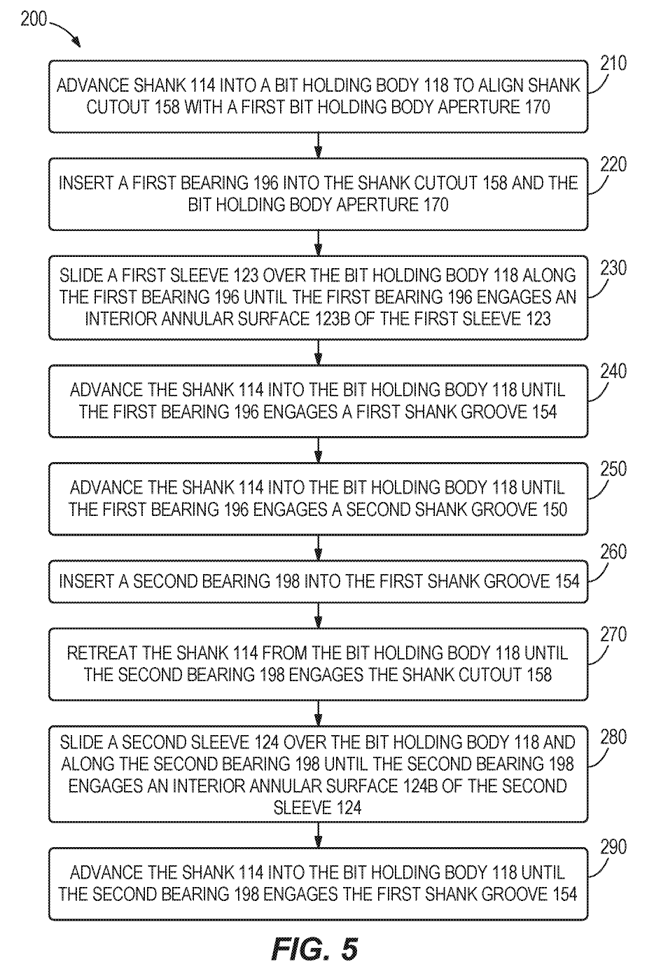

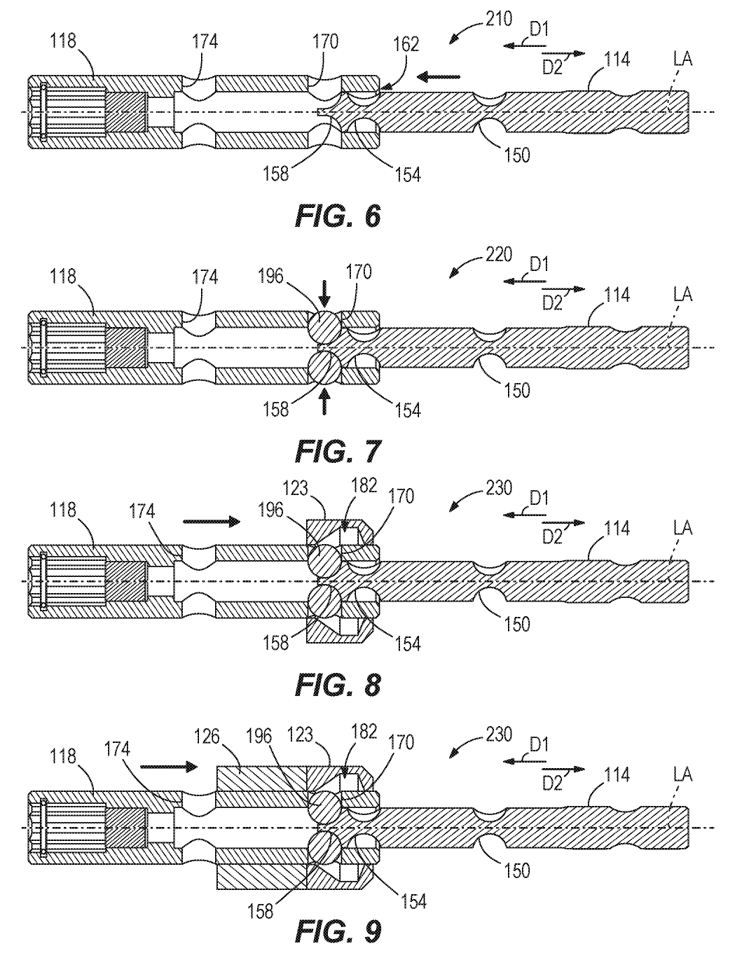

FIG. 5 is a flowchart depicting a method 200 of manufacturing or assembling the bit holder 110. The method 200 includes a plurality of steps 210-290 described and discussed with regard to FIGS. 6-17 as described below. The method 200 generally improves an assembly process of the bit holder 110 as described in detail below. Although the method 200 includes a series of steps, not all of the steps need to be performed or need to be performed in the order presented.

FIG. 6 illustrates a shank insertion step 210 whereby the shank 114 is advanced in the forward direction D1 into the longitudinal bore 162 of the bit holding body 118 until the cutout 158 is radially aligned with first apertures 170.

FIG. 7 illustrates a first bearing insertion step 220 whereby the first bearings 196 are passed through the first apertures 170 and into engagement with the cutout 158. When fully seated on the cutout 158, the first bearings 196 are at least partially positioned within the first apertures 170.

FIG. 8 illustrates a first sleeve introduction step 230 whereby the first sleeve 123 is slid over the bit holding body 118 in the reverse direction D2 and along the first bearings 196 until the first bearings 196 engage the interior annular surface 123b of the first sleeve 123. More specifically, the first sleeve 123 is slid in the reverse direction D2 such that the first bearings 196 engage the interior annular surface 123b at the end portion 182c, is further slid in the reverse direction D2 such that the first bearings 196 are located within the first sleeve groove 182 at the cylindrical portion 182b, and is further slid in the reverse direction D2 along the transition portion 182a and again engages the interior annular surface 123b. The depth of the cutouts 158 permit the first sleeve 123 to be slid in the first sleeve introduction step 230 in this manner.

FIG. 9 illustrates insertion of the flexible sleeve 126 in the reverse direction D2 around the bit holding body 118 and against the first sleeve 123. As discussed above, the bit holder 110 may have either the flexible sleeve 126 or a combination of the spring 125 and the shroud 122. The spring 125 may be inserted in a similar manner to the flexible sleeve 126 in the reverse direction D2 after the first sleeve introduction step 230. In embodiments with the spring 125 and the shroud 122, the shroud 122 may be overmolded or otherwise coupled to the first sleeve 123 prior to the first sleeve introduction step 230.

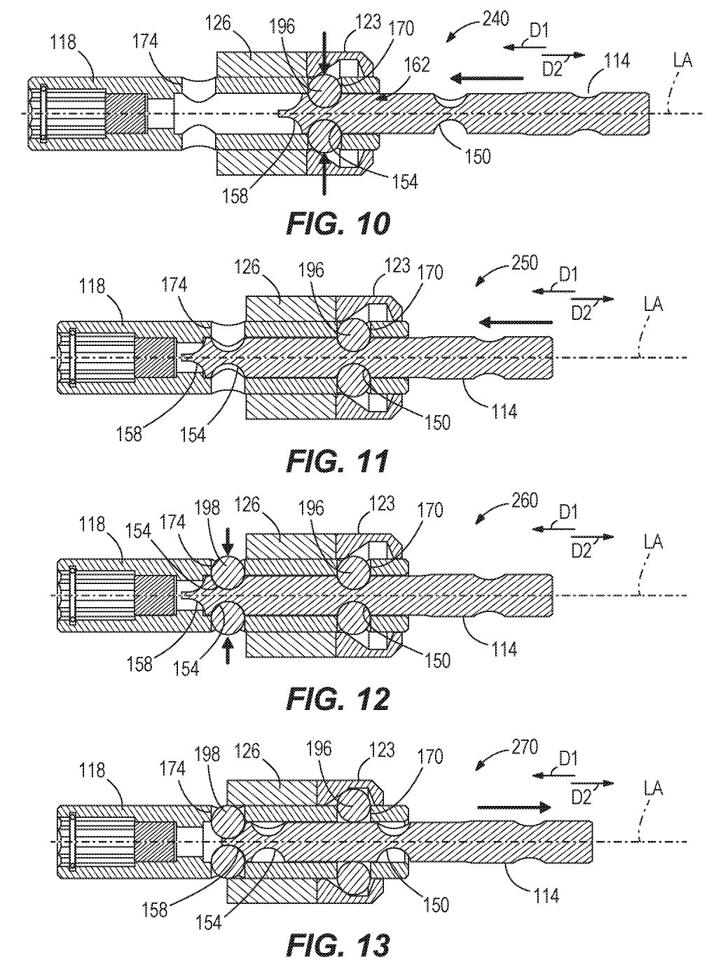

FIG. 10 illustrates a first shank advancing step 240 whereby the shank 114 is advanced along the forward direction D1 into the longitudinal bore 162 of the bit holding body 118 until the first bearings 196 engage the second grooves 154. While providing force to the shank 114 in the forward direction D1, the first bearings 196 engage the outer surface 146 of the shank 114 and are passed radially outwardly along the transition portion 182a and through the first apertures 170, into the first sleeve groove 182. Once aligned with the second grooves 154, the first bearings 196 are passed out of the first sleeve groove 182 radially inwardly back along the transition portion 182a and through the first apertures 170 to be seated in the second grooves 154.

FIG. 11 illustrates a second shank advancing step 250 whereby the shank 114 is further advanced along the forward direction D1 into the longitudinal bore 162 of the bit holding body 118 until the first bearings 196 engage the first grooves 150. While providing force to the shank 114 in the forward direction D1, the first bearings 196 engage the outer surface 146 of the shank 114 between the first grooves 150 and the second grooves 154, and the first bearings 196 are passed radially outwardly along the transition portion 182a and through the first apertures 170, into the first sleeve groove 182. Once aligned with the first grooves 150, the first bearings 196 are passed out of the first sleeve groove 182 radially inwardly back along the transition portion 182a and through the first apertures 170 to be seated in the first grooves 150. At the conclusion of the second shank advancing step 250, the second grooves 154 are radially aligned with second apertures 174.

FIG. 12 illustrates a second bearing insertion step 260 whereby second bearings 198 are passed through the second apertures 174 and into engagement with the second grooves 154. When fully seated on the second grooves 154, the second bearings 198 are at least partially positioned within the second apertures 174.

Insertion of the flexible sleeve 126 (FIG. 9) or the spring 125 may occur at any time after the first sleeve introduction step 230 and before the second bearing insertion step 260. For example, the first shank advancing step 240 and the second shank advancing step 250 may proceed the insertion of the flexible sleeve 126 or spring 125.

FIG. 13 illustrates a shank retreating step 270 whereby the shank 114 is retreated in the reverse direction D2 until the second bearings 198 engage the cutout 158. During the shank retreating step 270, the first bearings 196 move radially outwardly along the transition portion 182a and into the cylindrical portion 182b of the first sleeve groove 182. During the shank retreating step 270, if present, the flexible sleeve 126 (or the spring 125 and shroud 122) may inhibit the second bearings 198 from being ejected from the bit holder 110 in a radially outboard direction with respect to the axis LA. Alternately, a user or machine may apply force in a radially inward direction as illustrated in FIG. 12 to inhibit the second bearings 198 from being ejected. While providing force to the shank 114 in the reverse direction D2, the second bearings 198 are passed along the outer surface 146 of the shank 114 between the cutout 158 and the second grooves 154. Once aligned with the cutout 158, the second bearings 198 are moved radially inwardly through the second apertures 174 to be seated in the cutouts 158. When seated in the cutouts 158, the second bearings 198 are closer to the axis LA in comparison to when in the second grooves 154. The shank retreating step 270 allows the bit holder 110 to be manufactured with the second bearings 198 temporarily held in the cutouts 158 prior to introduction of the second sleeve 124. The cutouts 158 inhibit the second bearings 198 from falling into the longitudinal bore 162 during assembly.

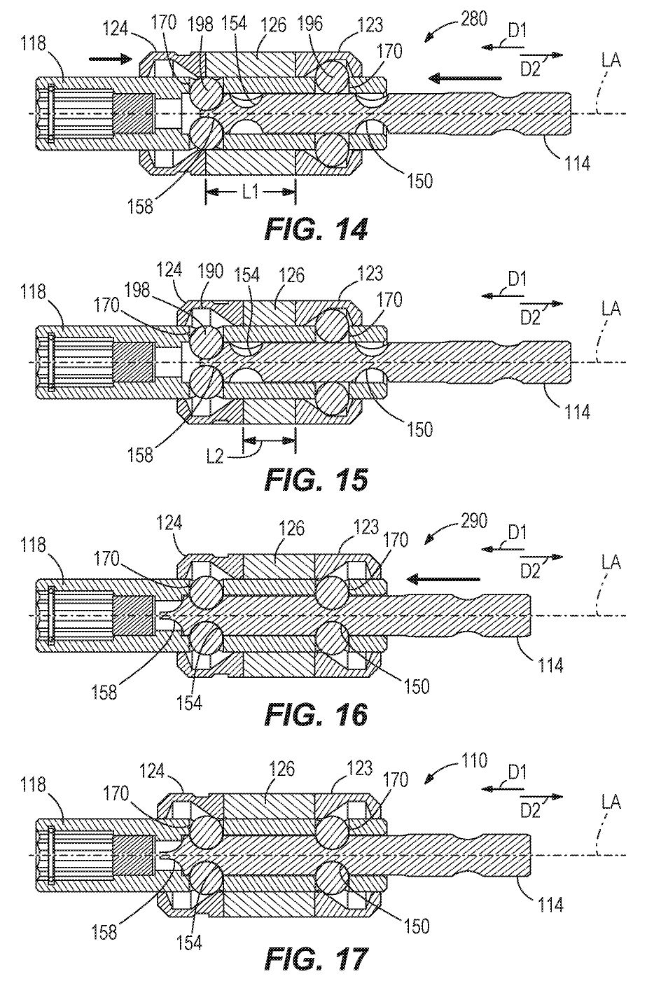

FIG. 14 illustrates a second sleeve introduction step 280 whereby the second sleeve 124 is slid over the bit holding body 118 in the reverse direction D2 and along the second bearings 198 until the second bearings 198 engage the interior annular surface 124b of the second sleeve 124. During the second sleeve introduction step 280, the second bearings 198 are positioned within the cutouts 158 and the first bearings 196 contact the outer surface 146 of the bit holding body 118 between the first grooves 150 and the second grooves 154. At the conclusion of the second sleeve introduction step 280, the second bearings 198 engage the interior annular surface 124b of the second sleeve 124.

FIG. 15 illustrates compression of the flexible sleeve 126 to radially align the second bearings 198 with the second sleeve groove 190 of the second sleeve 124. In the illustrated embodiment, the flexible sleeve 126 is compressed from an initial length L1 at the conclusion of the second sleeve introduction step 280 to a compressed length L2 of approximately 60% the initial length L1. In other embodiments, the ratio of compressed length L2 may differ. In the illustrated embodiment, a difference between the initial length L1 and the compressed length L2 may be between 5 millimeters and 6 millimeters. In other embodiments, the difference between the initial length L1 and the compressed length L2 may differ.

FIG. 16 illustrates a third shank advancing step 290 whereby the shank 114 is advanced along the forward direction D1 until the second bearings 198 engage the second grooves 154 and the first bearings 196 reengage the first grooves 150. During the third shank advancing step 290, the second bearings 198 are positioned within the second sleeve groove 190 and travel along the outer surface 146 of the bit holding body 118 between the cutout 158 and the second grooves 154. Similarly during the third shank advancing step 290, the first bearings 196 are positioned within the first sleeve groove 182 and travel along the outer surface 146 of the bit holding body 118 between the second grooves 154 and the first grooves 150. When nearing completion of the third shank advancing step 290, the transition portions 182a, 190a, force the first and second bearings 196, 198 into the first and second grooves 150, 154, respectively. FIG. 17 illustrates release of compression of the flexible sleeve 126 and the fully assembled bit holder 110 in the normal state. The bit holder 110 illustrated in FIG. 17 with a flexible sleeve 126 may be similarly movable to the torque overload position as described above and illustrated in FIG. 4B.

The method 200 allows the bit holder 110 to be assembled accurately and with high repeatability. Due to the shank retreating step 270 whereby the second bearings 198 are held in an intermediate position with the cutouts 158 of the shank 114 and with the shank 114 in a secure axial position along the axis LA, the method 200 inhibits one or more second bearings 198 from undesirably falling into the longitudinal bore 162, whereby the assembly process must be reversed to retrieve the one or more lost second bearing 198. In addition, the method 200 allows the bit holder 110 to be assembled without clips or other retaining members to hold the components together. For example, the bit holder 110 does not include spring clips that engage an outer surface of the bit holding body 118 to hold the first and second sleeves 123, 124 on the bit holding body 118. Instead, the first and second sleeves 123, 124 are held on the bit holding body 118 by the bearings 196, 198.

As described above, some or all illustrated features may be omitted in a particular implementation within the scope of the present disclosure, and some illustrated features may not be required for implementation of all embodiments. The features described above may be implemented in an order different from the order described above and do not prohibit implementation in another order or combination. While not explained in detail for each embodiment and/or construction, the features of the disclosure described herein may be included on a bit holder independent of other features and are not limited to the illustrated disclosure. Embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

Although the invention has been described in detail with reference to certain preferred embodiments, variations and modifications exist within the scope and spirit of one or more independent aspects of the invention as described.

Various features of the invention are set forth in the following claims.

1. A bit holder configured to be driven by a power tool, the bit holder comprising:
a shank extending along an axis, the shank having a tool end configured to be coupled to the power tool and a bit end opposite the tool end, the shank defining a groove of a first depth and a cutout of a second depth that is greater than the first depth, the cutout being closer than the groove to the bit end;
a bit holding body defining a longitudinal bore that receives a portion of the shank and an aperture defined in a surface of the bit holding body that is in fluid communication with the longitudinal bore; and
a bearing received at least partially in the aperture;
wherein the bearing is movable to the cutout to permit a sleeve to be moved along the bit holding body and into position surrounding the groove.

2. The bit holder of claim 1, wherein the cutout is positioned at the bit end.

3. The bit holder of claim 1, wherein the cutout is semi-circular in shape and extends in a radially inward direction from an outer surface of the shank.

4. The bit holder of claim 1, wherein the cutout intersects with the bit end to form a quarter circle revolved around the axis.

5. The bit holder of claim 1, wherein the bearing is movable to the cutout during assembly of the bit holder.

6. The bit holder of claim 1, wherein
the bit holding body also defines a second aperture;
the bit holder further comprises a second bearing received at least partially in the second aperture;
the shank defines a second groove of a third depth that is less than the second depth; and
the second bearing is movable to the cutout to permit the sleeve to be moved along the bit holding body and into position surrounding the second groove.

7. A bit holder configured to be driven by a power tool, the bit holder comprising:
a shank extending along an axis, the shank configured to be coupled to the power tool, the shank defining a groove;
a bit holding body defining a longitudinal bore that receives a portion of the shank, the bit holding body having an outer surface; and
a sleeve disposed over the shank and the bit holding body, the sleeve movable relative to the shank and the bit holding body to shift the bit holder between a first state, in which the shank is configured to transfer torque from the power tool to the bit holding body, and a second state, in which the shank is rotatable independently of the bit holding body;
wherein the sleeve is secured to the bit holding body without a clip.

8. The bit holder of claim 7, wherein the sleeve is secured to the bit holding body by a bearing.

9. The bit holder of claim 8, wherein the bearing secures the sleeve to the bit holding body by contact with a sleeve groove of the sleeve and the groove of the shank.

10. The bit holder of claim 8, wherein the bearing is movable between a normal position for torque transfer from the shank to the bit holding body through the bearing and a torque overload position whereby torque does not transfer from the shank to the bit holding body.

11. The bit holder of claim 10, wherein the normal position coincides with an inboard position of the bearing, and the torque overload position coincides with an outboard position of the bearing.

12. The bit holder of claim 11, wherein the sleeve defines a sleeve groove with a variable inner dimension transition portion to permit movement of the bearing between the normal position and the torque overload position.

13. The bit holder of claim 9, further comprising a spring configured to absorb overload torque and a shroud coupled to the sleeve, the shroud shielding the spring from the surroundings.

14. A method of assembling a bit holder, the method comprising:
advancing a shank into a bit holding body to align a shank cutout of the shank with a first bit holding body aperture of the bit holding body;
inserting a first bearing into the shank cutout and the first bit holding body aperture;
sliding a first sleeve over the bit holding body until a first sleeve groove of the first sleeve aligns with the first bearing; and
subsequently advancing the shank into the bit holding body such that the first bearing disengages the shank cutout and engages a first shank groove of the shank.

15. The method of claim 14, further comprising further advancing the shank into the bit holding body such that the first bearing disengages the first shank groove and engages a second shank groove of the shank.

16. The method of claim 15, further comprising inserting a second bearing into the first shank groove and a second bit holding body aperture of the bit holding body after the first bearing engages the second shank groove.

17. The method of claim 16, further comprising retreating the shank from the bit holding body such that the second bearing disengages the first shank groove and engages the shank cutout.

18. The method of claim 17, further comprising:
sliding a second sleeve over the bit holding body until a second sleeve groove of the second sleeve aligns with the second bearing; and
subsequently advancing the shank into the bit holding body such that the second bearing disengages the shank cutout and engages the first shank groove of the shank.

19. The method of claim 18, further comprising inserting a spring between the first sleeve and the second sleeve.

20. The method of claim 19, further comprising compressing the spring between the first sleeve and the second sleeve to align the second sleeve groove with the second bearing.
